(19) United States
(12) Patent Application Publication
(10) Pub. No.: US 2026/0269722 A1
(43) Pub. Date: Sep. 10, 2026

(54) HIGH STEP-DOWN POINT-OF-LOAD DC-DC POWER CONVERTER WITH CAPACITIVE ENERGY TRANSFER

(71) Applicant: THE REGENTS OF THE UNIVERSITY OF CALIFORNIA, Oakland, CA (US)

(72) Inventors: Nathan Ellis, Emeryville, CA (US); Robert Pilawa-Podgurski, Alameda, CA (US)

(73) Assignee: THE REGENTS OF THE UNIVERSITY OF CALIFORNIA, Oakland, CA (US)

(21) Appl. No.: 19/650,836

(22) Filed: Apr. 17, 2026

Related U.S. Application Data
(63) Continuation of application No. PCT/US2024/056279, filed on Nov. 15, 2024.
(60) Provisional application No. 63/600,362, filed on Nov. 17, 2023.

(51) Int. Cl. H02M 3/07; H02M 1/00; H02M 3/158

(52) U.S. Cl. CPC H02M 3/07; H02M 1/0043; H02M 1/0095; H02M 3/158

(57) ABSTRACT

A Hybrid Switched Capacitor Converter (HSCC) topology is presented that is suitable for high conversion ratio Point-of-Load (POL) applications. The topology specifically targets 48V to 1V power delivery in space-based high-performance computing systems, where size and weight are important considerations, along with device de-rating for radiation tolerance. One implementation merges an initial 2:1 switched capacitor conversion stage with a symmetric dual inductor hybrid (SDIH) conversion stage, reaping benefits of both. The SDIH stage offers reduced component count and an excellent switch stress figure of merit, while the initial 2:1 voltage reduction stage significantly reduces the volume of flying capacitors, enabling compact size and low weight.

### CROSS-REFERENCE TO RELATED APPLICATIONS

This application claims priority to, and is a 35 U.S.C. § 111(a) continuation of, PCT international application number PCT/US2024/056279 filed on Nov. 15, 2024, incorporated herein by reference in its entirety, which claims priority to, and the benefit of, U.S. provisional patent application Ser. No. 63/600,362 filed on Nov. 17, 2023, incorporated herein by reference in its entirety. Priority is claimed to each of the foregoing applications.

The above-referenced PCT international application was published as PCT International Publication No. WO WO 2025/106919 A1 on May 22, 2025, which publication is incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### 1. TECHNICAL FIELD

The technology of this disclosure pertains generally to hybrid switched-capacitor converters, and more particularly to merging a conversion stage with a Symmetric Dual Inductor Hybrid (SDIH) conversion stage.

### 2. BACKGROUND DISCUSSION

Hybrid Switched-Capacitor converters (HSCCs) have demonstrated high performance in regulating 48V to Point-of-Load (POL) applications, owing to both their reduced total switch stress and required passive component volume. The reduced switching device voltage stress in these converter topologies makes them particularly applicable to high density and light weight space applications which additionally require immunity to radiation effects such as Total Ionizing Dose (TID) and Single Event Effects (SEE). In these applications, devices must typically be de-rated well below their terrestrial limits, motivating the use of multi-level and higher order HSCCs.

Accordingly, a need exists for high-performance power conversion circuitry which overcomes limitations of existing systems. The present disclosure fulfills that need and provides additional benefits over existing systems.

### BRIEF SUMMARY

This disclosure describes a Hybrid Switched Capacitor Converter (HSCC) topology suitable for high conversion ratio Point-of-Load (POL) applications, specifically targeting, in at least one embodiment, 48V to 1V power delivery in space-based high-performance computing systems, where size and weight are important considerations, along with device de-rating for radiation tolerance. Assisting this effort, Gallium Nitride (GaN) switching devices may be utilized which offer inherent radiation hardness and peak figures of merit in the tens to hundreds of volts, further motivating the use of GaN-based HSCCs in future spacecraft and satellite power delivery systems.

In one embodiment, the topology merges an initial switched capacitor conversion stage, such as a conventional 2:1 stage, with a recently developed symmetric dual inductor hybrid (SDIH) conversion stage, with the combination providing unexpected benefits. The SDIH stage offers reduced component count and an excellent switch stress figure of merit, while the initial 2:1 voltage reduction stage significantly reduces the volume of flying capacitors, allowing the converters to be implemented in a compact size and a low weight. A high density gate drive solution is also presented in detail, using a minimal number of driver Integrated Circuits (ICs) without compromising drive capability. A preliminary hardware prototype demonstrates the feasibility of this topology while employing de-rated gallium nitride (GaN) switches to safeguard against radiation Total Ionizing Dose (TID) and Single Event Effects (SEE).

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a schematic diagram of a power converter topology combining an initial Switched-Capacitor (SC) stage with a Symmetric Dual Inductor Hybrid (SDIH), according to at least one embodiment of the present disclosure.

FIG. 2A through FIG. 2D are schematics showing simplified phase progression in the power converter shown in FIG. 1, according to at least one embodiment of the present disclosure.

FIG. 3A and FIG. 3B are graphs comparison stored flying capacitor energy in a conventional 12^{th} order single stage SDIH converter (FIG. 3A) compared with the merged two stage power converter (FIG. 3B), according to at least one embodiment of the present disclosure.

FIG. 4 is a schematic of a hardware prototype of the disclosed power converter showing gate driving and associated power delivery, according to at least one embodiment of the present disclosure.

FIG. 5 is a plot showing measured output and switched node voltage waveforms for the schematic of FIG. 4, according to at least one embodiment of the present disclosure.

FIG. 6 is a rendition of a photograph showing the top side of a hardware prototype, according to at least one embodiment of the present disclosure.

FIG. 7 are plots of measured efficiency curves for the hardware prototype depicted in FIG. 6, according to at least one embodiment of the present disclosure.

### DETAILED DESCRIPTION

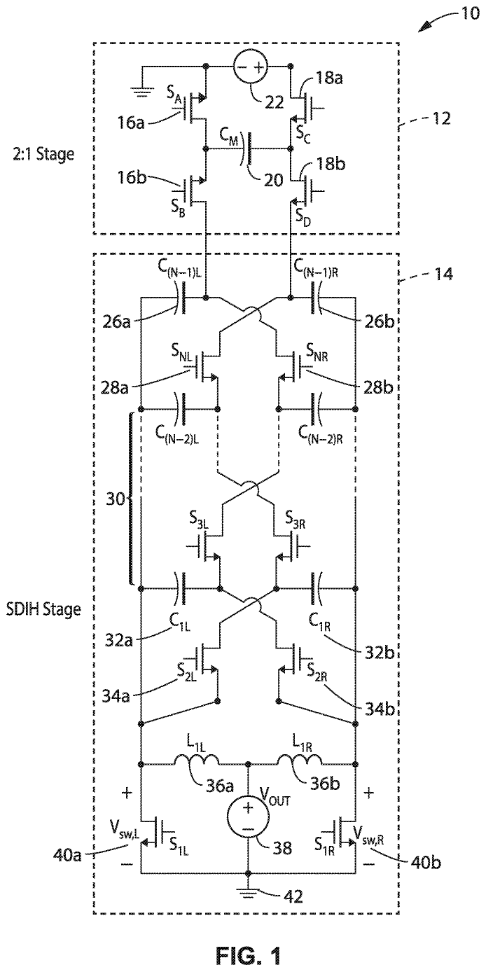

While Hybrid Switched Capacitor Converter (HSCC) devices have received significant development for use in terrestrial data centers, this disclosure describes a direct 48V to 1V HSCC power converter topology that is also suitable for high performance computing in space. FIG. 1 provides an example of the power converter topology according to this disclosure.

In the following, Section 1 describes operation of HSCC topology and motivates its merged two-stage power converter structure. Section 2 presents an embodiment of a hardware prototype validating the structure of this disclosure, in addition to a compact gate drive scheme for practical implementation. Section 3 further summarizes the technology of this disclosure.

### 1. Power Converter Topology

FIG. 1 illustrates an example embodiment 10 of a power converter topology according to this disclosure that comprises an initial switched capacitor conversion stage 12, exemplified as providing 2:1 conversion, which is merged with the Symmetric Dual Inductor Hybrid (SDIH) topology 14. The disclosed circuit with these interoperating stages requires fewer components compared to conventional designs, and provides additional advantages. This merging of stages is seamlessly facilitated by the symmetric dual inductor hybrid (SDIH) converter's inherent dual interleaved high-side port that can draw charge off of the 2:1 stage's flying capacitor C_{M} in an alternating fashion, to significantly reduce capacitor volume requirements, while simultaneously removing multiple (e.g., two) redundant switches compared to two stand-alone stages.

By way of example and not limitation, the switches are exemplified as Metal Oxide Semiconductor Field Effect Transistors (MOSFETs), Gallium Nitride (GaN) transistors, or other forms of transistor switches which can handle the environmental the circuit requirements. It should be appreciated that other types of devices may be utilized to provide the switching function without departing from the teachings of the present disclosure. For the sake of simplicity of illustration, the circuitry driving the control inputs (gates) of these switches is not shown.

In particular, the first stage is shown receiving power input 22 of V_{IN} (e.g., 48 V) which is directed to a switched capacitor matrix. A first set of series switches is shown with switch 16a (S_{A}) is connected between a negative (ground) of source V_{IN} 22 and a first end of capacitor 20 (C_{M}), and then through switch 16b (S_{B}) to a first input on second stage 14.

A second set of series switches is shown with switch 18a (S_{C}) is connected between a positive side of source V_{IN} 22 and a second end of capacitor 20 (C_{M}), and then through switch 18b (S_{D}) to a second input on second stage 14.

In one phase of operation switches 18a, and 16b are active, and in a later phase switches 16a and 18b are active, in each of these phases the average voltage across the capacitor is ½ V_{IN}.

The SDIH stage is configured with left and right capacitors and interleaved switches in each of its substages, followed by a switched L substage at the output. A background publication describing SDIH converters such as used for the SDIH stage of this disclosure is: N. M. Ellis, R. A. Abramson, R. Mahony and R. C. N. Pilawa-Podgurski, “The Symmetric Dual Inductor Hybrid Converter for Direct 48V-to-Pol Conversion,” in IEEE Transactions on Power Electronics, vol. 39, no. 6, pp. 7278-7289 June 2024, doi: 10.1109/TPEL.2023.3259949, published online Mar. 28, 2023, incorporated herein by reference in its entirety.

More specifically, FIG. 1 depicts a first output from the first stage coupled between a capacitor 26a C_{(N-1)L} leading to a capacitor negative-side line for the other capacitors on the left side, and to a switch 28b (S_{NR}) out for charging a capacitor of a second substage, which is interleaved between left and right sides progressing through these successive substages. A second output from the first stage is coupled between a capacitor 26b C_{(N-1)R} leading to a capacitor negative-side line for the other capacitors on the right side, and to a switch 28a (S_{NL}) out for charging a capacitor of a second substage, which is interleaved between right and left sides progressing through these successive substages.

Section 30 represents any desired number of intermediate substages, symbolized as capacitors C_{(N-2)L} and C_{(N-2)R} and associated left and right switches, the last of which in intermediate substages are switch S_{3L} and S_{3R}.

A final substage is shown with receiving L and R inputs from the previous substage between capacitor 32a C_{1L} and switch 34b S_{2R}, and capacitor 32b C_{1R} and switch 34a S_{2L}. The outputs of these switches connected to the capacitor negative-side line.

An output stage is shown comprising inductors 36a L_{1L} and 36b L_{1R} which are each coupled from a negative-side to a positive output of V_{OUT} 38. Switches V_{SW,L} 40a, and V_{SW,R} 40b switch their respective negative-side lines to the negative output of V_{OUT} 38. The following figures show the active paths for each of the four operating phases of the circuit of FIG. 1.

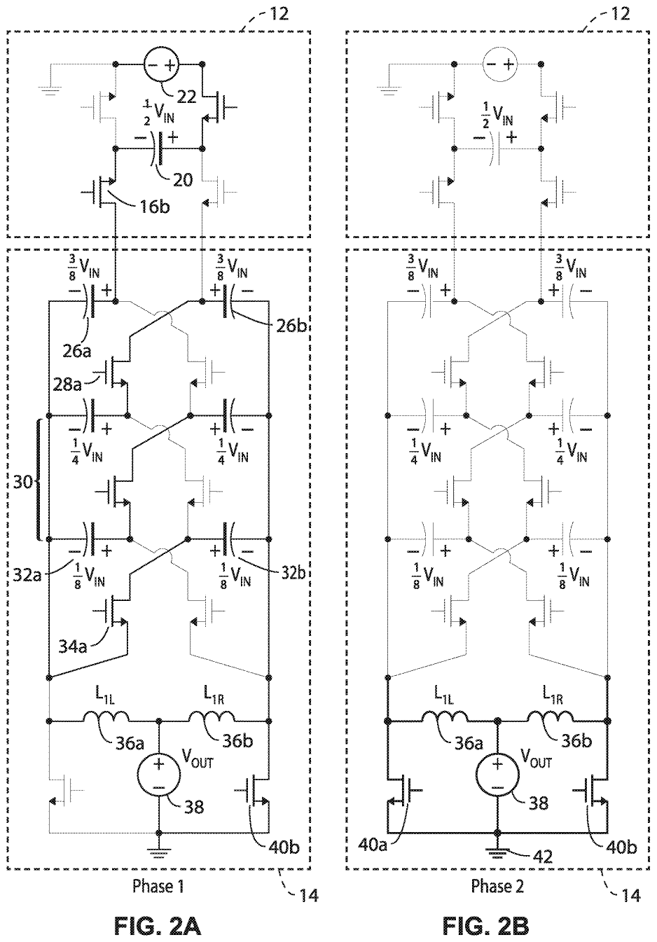

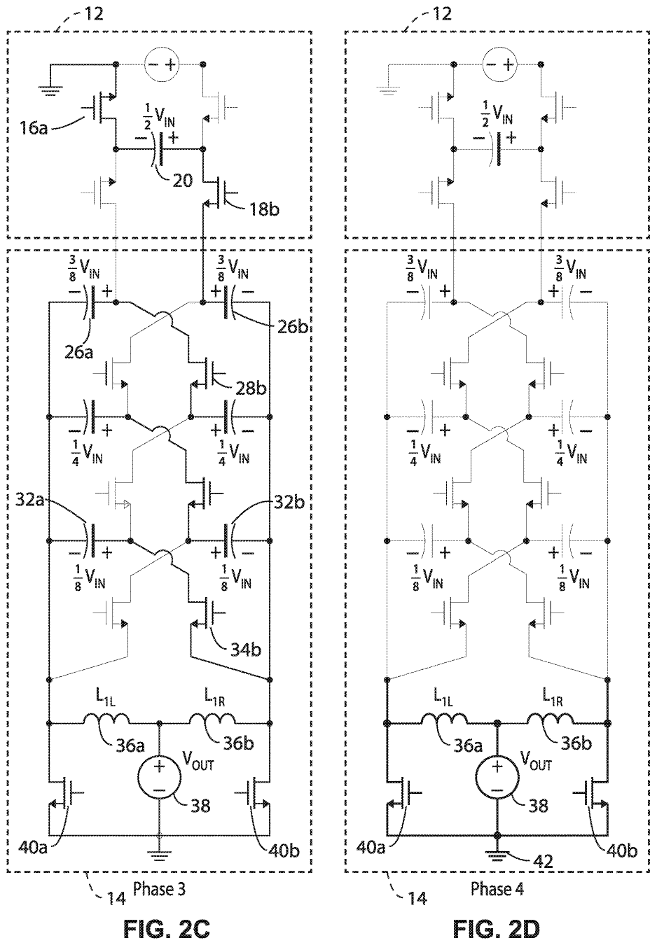

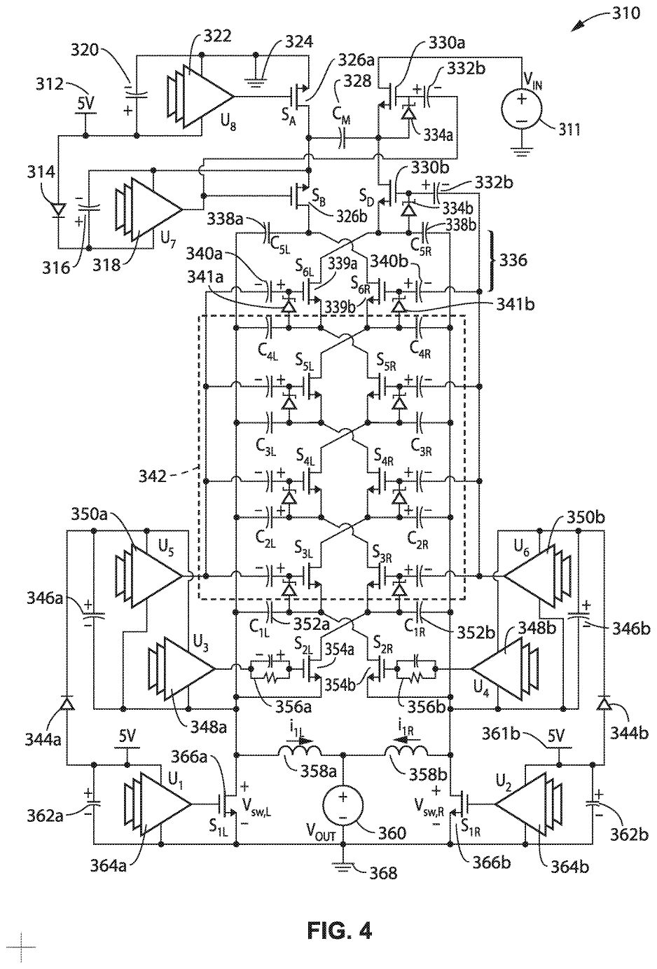

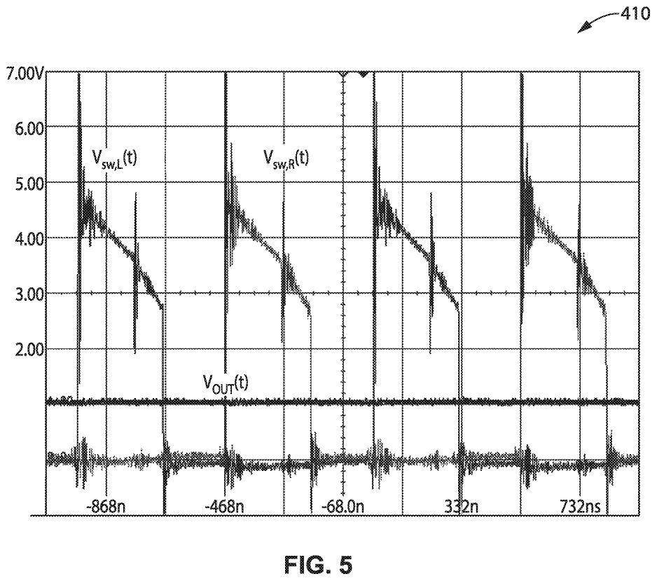

FIG. 2A through FIG. 2D illustrate a phase progression, phase 1 through phase 4, of the power converter shown in FIG. 1, having added free-wheeling phases 2 (FIG. 2B) and 4 (FIG. 2D) to facilitate Pulse Width Modulation (PWM) voltage regulation. For the embodiment depicted in FIG. 2A through FIG. 2D, a merged 4^{th} order second-stage SDIH is utilized as the second stage. All switches are subjected to a fraction of the input voltage, and act to conduct charge through the capacitor network during phase 1 (FIG. 2A) and phase 3 (FIG. 2C). The capacitors store decreasing DC voltages, from input to output, facilitating a staircase descent in voltage as charge progresses through the network. Added phases 2 and 4 are “free-wheeling” regulation phases whose relative duration may be modulated to enable output voltage regulation. The switched voltage waveforms produced at either output inductor before the output are interleaved by 180°, facilitating effective use of coupled inductors for reduced size and improved transient response. Example switched voltage waveforms are further depicted in FIG. 5.

Provided that all flying capacitors are sized equally, this merging of stages has the added benefit of removing all requirements for split-phase switching, with the exception of the lowermost capacitor branch in both phase 1 and phase 3. Here split-phase switching refers to a modified switch control technique involving the delayed or advanced activation or deactivation of certain switches within an associated primary phase depicted in FIG. 2A through FIG. 2D. However, assuming capacitor voltage ripple is kept small, split-phase switching may be neglected, as was done in FIG. 2 for the sake of simplicity.

As a Dickson-type structure, the SDIH stage expresses best-in-class switch stress Figure Of Merit (FOM), with each switch within the SDIH stage subjected to a maximum blocking voltage of VIN/N, where N defines the SDIH order as annotated in FIG. 1. This translates to an ability to use smaller switches while achieving equivalent performance. Despite this advantage, Dickson converters typically fare worse with respect to passive component volume as a compromise.

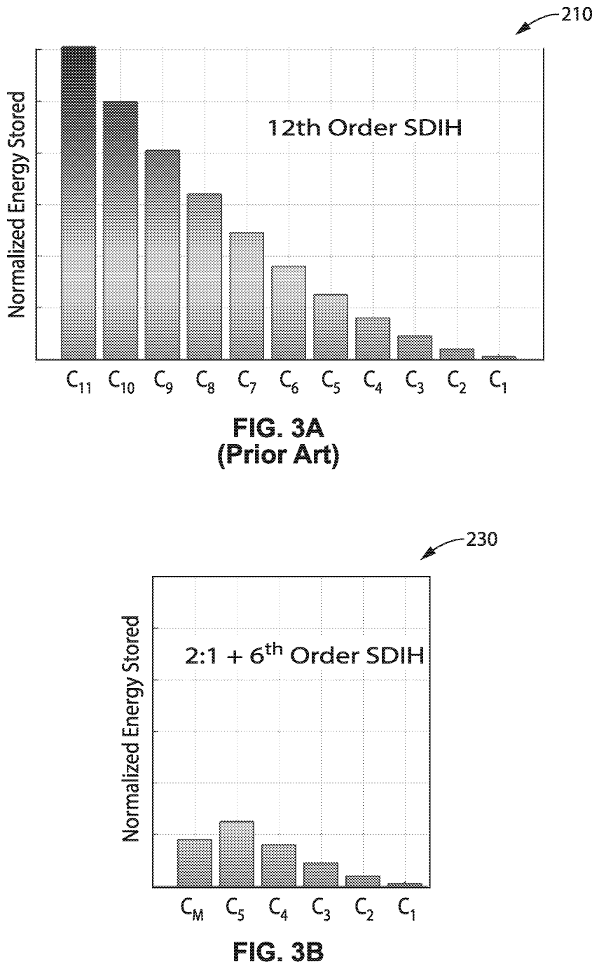

FIG. 3A and FIG. 3B illustrate a comparison of stored flying capacitor energy in two 12:1 switched capacitor solutions, where both FIG. 3A and FIG. 3B have identical vertical y-axis scaling.

In FIG. 3A is shown normalized energy stored in a single stage SDIH converter, with the graph depicting normalized energy stored in capacitors C₁ through to C₁₁, for a 12^{th} order single stage SDIH converter. The normalized energy stored in each flying capacitor of this example 12^{th} order SDIH converter, is shown in which energy

$$\frac{1}{2} ( C {V}^{2} )$$

is largely proportional to capacitor volume. It should be noted that the stored energy in C₁ through C₁₁, each represent the combined energy stored in a left and right capacitor (C_{NL}+C_{NR}). In this example, capacitors C_{11L} and C_{11R} must be rated at

$$\frac{11}{12} \times {V}_{IN}$$

and store the largest amount of energy as a result of the amount stored growing with the square of rated voltage.

In FIG. 3B normalized energy stored on capacitors C₁ through C₅ and C_{M} is shown for one embodiment of the merged two stage power converter of the present disclosure, which leverages an initial 2:1 reduction followed by a 6^{th} order merged SDIH stage. The stored energy in C₁ through C₅ each represent the combined energy stored in a left and right capacitor.

By interoperating with the initial stage (e.g., 2:1), only a subsequent 6th order SDIH stage is required for the same overall conversion ratio as the standalone 12^{th} order SDIH, which significantly reduces total parts count. Moreover, due to the initial halving in voltage, capacitors C_{M}, C_{5L}, and C_{5R} need only be rated for V_{IN}/2 resulting in an approximate 7× reduction in total capacitor volume. This passive volume reduction comes in exchange for a somewhat worsened overall switch stress, since switches S_{A} (16a), S_{B} (16b), S_{C} (18a) and S_{D} (18b) must be rated for an increased voltage of V_{IN}/2.

### 2. Hardware Prototype

FIG. 4 illustrates the schematic 310 of a hardware prototype for the Hybrid Switched Capacitor Converter (HSCC), which unlike FIG. 1, depicts all gate drivers and associated power delivery circuitry.

This circuit is shown having the same primary topology as seen in FIG. 1. In particular, the same first stage is shown with a first set of series switches 326a (S_{A}) is connected to capacitor 328 (C_{M}), and then through switch 326b (S_{B}) to a first input on the second stage comprising SDIH inputs. A second set of series switches 330a (S_{C}) is connected to a second end of capacitor 328 (C_{M}) and then through switch 330b (S_{D}) to a second input on second stage SDIH input.

The SDIH stage in this example is depicted with a fixed number of substages, each configured with left and right capacitors and interleaved switches in each of its substages, followed by a switched L substage at the output. At the input 336 are capacitors 338a (C_{5L}) and 338b (C_{5R}), along with switches 339a (S_{6L}) and 339b (S_{6R}).

Three additional substages are shown 342, before a final substage shown with receiving L and R inputs from the previous substage between capacitor 352a C_{1L} and switch 354b S_{2R}, and capacitor 352b C_{1R} and switch 354a S_{2L}. The outputs of these switches connected to the capacitor negative-side line.

An output stage is shown comprising inductors 358a L_{1L} and 358b L_{1R} to the positive output of V_{OUT} 360. Switches V_{SW,L} 366a, and V_{SW,R} 366b switch their respective negative-side lines to the negative output of V_{OUT} 360.

In this embodiment, gate drivers 350a (U₅) and 350b (U₆) are used to drive groups of switches in parallel, greatly reducing the number of gate drivers required. In this embodiment, power is delivered to high-side gate drivers using conventional diode bootstrapping, exemplified with diodes, 344a, 344b, although other embodiments may employ isolated power delivery of other energy delivery methods. Supply side gate driver bypass capacitors, are also shown 320, 362a, 362b, in addition to high-side gate driver bypass capacitors, 316, 346a, 346b.

Drivers 364a (U₁), 364b (U₂) and 322 (U₈) are ground referenced low-side drivers, whereas high-side drivers 348a (U₃), 348b (U₄), 350a (U₅), 350b (U₆) and 318 (U₇) leverage level-shifting circuitry integrated within a commercial half-bridge driver. Drivers U₃, U₄, U₅, U₆ and U₇ receive power via standard diode-based bootstrapping, also integrated within the chosen driver solution. Since the source of FETs S_{3L} through S_{6L} maintain a constant voltage offset, all may be driven directly by driver U₅, where capacitive coupling (340a) provides the necessary level-shifted V_{gs} signals, and gate-to-source Zener diodes (341a) ensure correct biasing of the level-shifting capacitors. Although U₅ would ideally be referenced to the source of S_{3L}, this would require an additional bootstrapping diode for power delivery. Instead, in this example U₅ is referenced to the source of S_{2L} (along with U₃); subsequently the load-induced voltage ripple imposed upon the flying capacitors is also imposed upon the V_{gs} gate signals stemming from driver U₅. However, Zener clamps (e.g., 5.6V) are shown on all substages, such as seen by 341a, 341b, ensuring that V_{gs}-imposed ripple can only cause slight degradation in drive strength (V_{gs} less than 5V), and that when low; V_{gs} is kept below turn-on threshold V_{TH}, avoiding any false turn-on. A similar capacitor voltage offset strategy is used for driving S_{C} (330a) using U₇ (318). Gate drivers U₃ and U₄ are utilized to optionally implement split-phase switching in the SDIH stage and includes a gate-connected circuit 356a, 356b having a capacitor biased at 0V (by a resistor) for delay matching purposes only.

The constructed power stage uses a 6th order SDIH to produce two interleaved switched node waveforms, V_{SW,L} and V_{SW,R}, each with an amplitude of 4V (equals 48V/2/6).

FIG. 5 illustrates experimentally captured waveforms 410 of V_{OUT}(t) and the interleaved switched node waveforms, V_{SW,L}(t) and V_{SW,R}(t). The duration of phases 2 and 4 is modulated to provide output voltage regulation to 1V, irrespective of load. The figure is labelled in accordance with the schematic in FIG. 4, and for V_{IN}=48V, V_{OUT}=1V, I_{OUT}=50 A, and f_{SW}=1 MHz. Inherent phase-shifted PWM facilitates the effective use of coupled inductors for ripple cancellation and improved transient response.

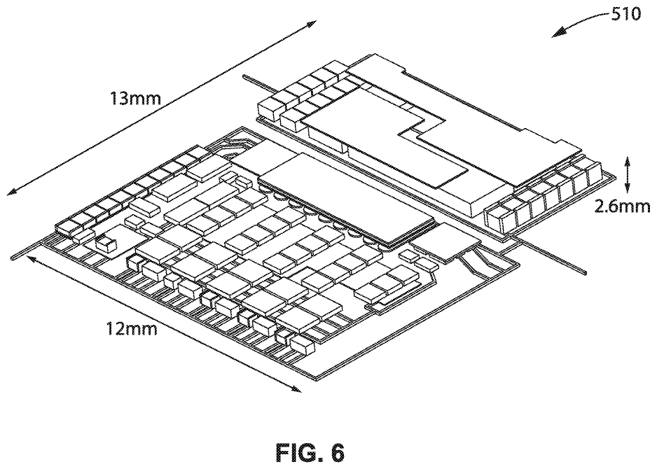

FIG. 6 illustrates a prototype 510 of the Hybrid Switched Capacitor Converter (HSCC) which achieves a very high measured power density of 2,020 W/inch³ (123.3 kW/liter). The prototype was fabricated and measures 13 mm×12 mm×2.6 mm, or 405.6 mm³ (0.02475 inch³), on a 0.9 mm thick PCB using a 6-layer stackup and 2 oz. copper metallization and includes a custom single-turn coupled inductor, according to an embodiment of the technology of this disclosure. Due to the converter's symmetry, the bottom side of the PCB is similar, but also contains capacitor bank C_{M}.

Table 1 lists component details, for the prototype HSCC.

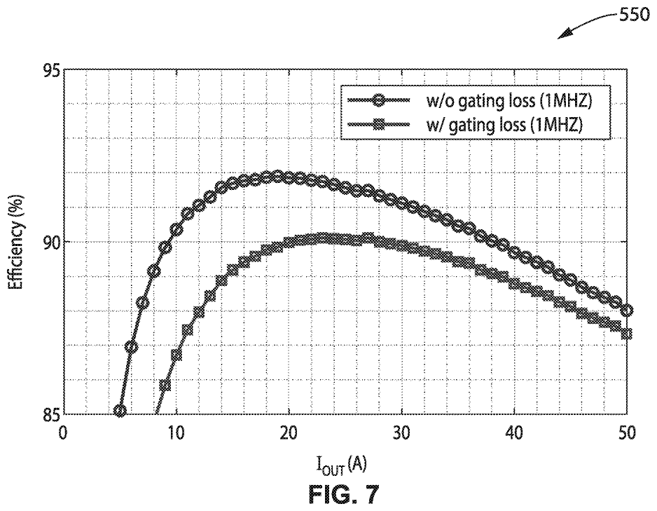

FIG. 7 are plots 550 of measured efficiency curves for V_{IN}=48V, V_{OUT}=1V for all datapoints, both with and without, accounting for gate driving losses. The prototype achieves peak and full-load efficiencies of 91.9% and 88% when ignoring gate driving losses, and 90.1% and 87.3% when including all losses.

Thermal behavior of the prototype was tested in steady-state operation at full load with V_{IN}=48V, V_{OUT}=1V, I_{OUT}=50 A, and f_{SW}=1 MHz. For a maximum tested current output of 50 A, and with regulation to 1V, the prototype setting at a low peak operating temperature of 58 degrees Celsius when subject to forced air cooling, whereby the prototype was found to remain relatively cool due to its high efficiency.

Finally, Table 2 compares the disclosed HSCC circuitry against other recent competitive 48V to 1V conversion demonstrations.

### 3. Conclusion

The present disclosure presents a new HSCC topology applicable to high conversion ratio Pol applications, including 48V to 1V power delivery. A high performance SDIH stage is employed for its effective use of switching devices, while an initial 2:1 voltage reduction stage eliminates most of the flying capacitor volume. The availability of high performance GaN devices with inherent radiation hardening makes this topology well suited for use in space applications that require increasing computing power. A hardware prototype of one embodiment of this disclosure validates both the topological structure and a compact gate driving scheme which uses 8 gate drivers to drive 16 switches. When performing 48V to 1V conversion, this prototype demonstrates a very high power density of 2,020 W/inch³ (123.3 kW/liter) while retaining efficiencies greater than 87%.

### 4. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A point-of-load hybrid switched capacitor converter (HSCC) apparatus, comprising: (a) a first stage comprising a switched capacitor converter (SCC) stage merged with a second stage comprising a symmetric dual-inductor hybrid (SDIH) Dickson-type converter stage; (b) wherein said SCC stage comprises switches on either end of a flying capacitor for power and ground input, and switches on either side of the flying capacitor whose outputs are coupled to the second stage; (c) wherein said first stage is fully softcharged by the second stage (SDIH) Dickson-type converter stage; and (d) wherein said SDIH converter interleaves two inductor loaded hybrid switched capacitor converters having switches which are arranged for mirrored switching operation.

A point-of-load hybrid switched capacitor converter (HSCC) apparatus, comprising: (a) a first stage comprising a 2:1 (two-to-one) switched capacitor converter (SCC) stage merged with a second stage comprising a symmetric dual-inductor hybrid (SDIH) Dickson-type converter stage; (b) wherein said SCC stage comprises switches on either end of a flying capacitor for power and ground input, and switches on either side of the flying capacitor whose outputs are coupled to the second stage; (c) wherein said first stage is fully softcharged by the second stage (SDIH) Dickson-type converter stage; (d) wherein said SDIH converter is a merged multi-order second-stage SDIH converter, which interleaves two inductor loaded hybrid switched capacitor converters having switches which are arranged for mirrored switching operation; (e) wherein output inductors in said SDIH stage employ coupled inductors for reducing size and enhancing transient response; (f) wherein operation of said HSCC apparatus is operated in two principle phases directed to different sides of the mirrored switching, and including additional free-wheeling phases which facilitate PWM voltage regulation; and (g) wherein said SDIH converter has an inherent dual interleaved high-side port capable of drawing charge from the flying capacitor of the SCC first stage, in an alternating fashion by the mirrored switching operation.

A point-of-load hybrid switched capacitor converter (HSCC) method, comprising: (a) merging a switched capacitor converter (SCC) first stage with a symmetric dual-inductor hybrid (SDIH) Dickson-type second converter stage; (b) performing switching in said SCC stage of switches on either end of a flying capacitor for power and ground input, and switches on either side of the flying capacitor whose outputs are coupled to the second stage; (c) fully softcharging said first stage by the second stage (SDIH) Dickson-type converter stage; and (d) interleaving two inductor loaded hybrid switched capacitor converters in said SDIH converter utilizing switches arranged for mirrored switching operation.

A point-of-load hybrid switched capacitor converter (HSCC) apparatus, comprising: (a) a first stage comprising a 2:1 (two-to-one) switched capacitor converter (SCC) stage merged with a second stage comprising a symmetric dual-inductor hybrid (SDIH) Dickson-type converter stage; (b) wherein said SCC stage comprises switches on either end of a flying capacitor for power and ground input, and switches on either side of the flying capacitor whose outputs are coupled to the second stage; (c) wherein said first stage is fully soft-charged by the second stage (SDIH) Dickson-type converter stage; and (d) wherein said SDIH converter interleaves two dual-inductor hybrid converters having switches which are arranged for mirrored split-phase switching.

The apparatus or method of any preceding implementation, wherein said first stage comprises a 2:1 (two-to-one) SCC stage.

The apparatus or method of any preceding implementation, wherein said switches comprise Gallium Nitride (GaN) or MOSFET switches.

The apparatus or method of any preceding implementation, wherein said gallium nitride, or MOSFET, switches are de-rated to safeguard against radiation total ionizing dose (TID) and single event effects (SEE).

The apparatus or method of any preceding implementation, wherein operation of said HSCC apparatus is operated in two principle phases directed to different sides of the mirrored switching, and including additional free-wheeling phases which facilitate PWM voltage regulation.

The apparatus or method of any preceding implementation, wherein said SDIH converter has an inherent dual interleaved high-side port capable of drawing charge from the flying capacitor of the SCC first stage, in an alternating fashion by the mirrored switching operation.

The apparatus or method of any preceding implementation, wherein said SDIH converter is a merged multi-order second-stage SDIH converter.

The apparatus or method of any preceding implementation, wherein said SDIH converter is a merged sixth-order second-stage SDIH converter.

The apparatus or method of any preceding implementation, wherein said converter apparatus provides conversion from 48 Volts to 1 Volt.

The apparatus or method of any preceding implementation, wherein output inductors in said second stage employ coupled inductors for reducing size and enhancing transient response.

The apparatus or method of any preceding implementation, wherein flying capacitors in the SDIH converter stage each have the same capacitance value.

The apparatus or method of any preceding implementation, wherein the merging of the SCC first stage with said SDIH converter second stage, in said HSCC apparatus, provides a reduction in required component count for the same overall voltage conversion ratio.

The apparatus or method of any preceding implementation, further comprising gate drivers for driving the switches, wherein said gate drivers comprise ground referenced low side drivers and high-side drivers.

The apparatus or method of any preceding implementation, wherein said high-side drivers leverage level-shifting circuitry integrated within a half-bridge driver.

The apparatus or method of any preceding implementation, wherein said switches comprise Gallium Nitride (GaN) switches, MOSFET, or other switch forms.

The apparatus of any preceding implementation, wherein said gallium nitride (GaN), or MOSFET, switches comprise de-rated switches to safeguard against radiation total ionizing dose (TID) and single event effects (SEE)

The apparatus of any preceding implementation, wherein operation of said HSCC apparatus is operated in two principle phases directed to different sides of the mirrored switching, and including additional free-wheeling phases which facilitate PWM voltage regulation.

The apparatus of any preceding implementation, wherein said SDIH converter has an inherent dual interleaved high-side port capable of drawing charge from the flying capacitor of the 2:1 SCC first stage, in an alternating fashion.

The apparatus or method of any preceding implementation, wherein said SDIH converter is a merged multi-order second-stage SDIH converter.

The apparatus or method of any preceding implementation, wherein said SDIH converter is a merged fourth-order second-stage SDIH converter.

The apparatus or method of any preceding implementation, wherein said converter apparatus provides conversion from a direct 48 Volts to 1 Volt.

The apparatus or method of any preceding implementation, wherein output inductors in said second stage are interleaved by 180 degrees to increase effective use of coupled inductors for reducing size and enhancing transient response.

The apparatus or method of any preceding implementation, wherein flying capacitors in the SDIH converter stage each have the same capacitance value.

The apparatus or method of any preceding implementation, wherein the merging of the SCC first stage with said SDIH converter second stage, in said HSCC apparatus, provides reduced component count and lowered switching stress.

The apparatus or method of any preceding implementation, further comprising gate drivers for driving the switches, wherein said gate drivers comprise ground referenced low side drivers and high-side drivers.

The apparatus or method of any preceding implementation, wherein said high-side drivers leverage level-shifting circuitry integrated within a half-bridge driver.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
Component Details

| Component | Description | Part Number |
|---|---|---|
| S_{A,B,C,D} | 100 V 23 mΩ GaN Tran. | 2 × EPC2070 |
| S_{1-6X} | 15 V 26 mΩ GaN Tran. | 2 × EPC2216 |
| S_{1X} | 40 V 1.1 mΩ GaN Tran. | 2 × EPC2066 |
| C_{M} | 1.5 μF (derated) | 4 × GRM155C61E475ME15 |
| C_{5,L/R} | 1.51 μF (derated) | 3 × GRM155C61E475ME15 |
| | | 1 × GRM155R61E225KE11D |
| C_{4,L/R} | 1.55 μF (derated) | 1 × GRM155C61E475ME15 |
| | | 3 × GRM155R61E225KE11D |
| C_{3,L/R} | 1.54 μF (derated) | 3 × GRM155R61E225KE11D |
| | | 1 × GRM155R61E105MA12D |
| C_{2,L/R} | 1.57 μF (derated) | 1 × GRM155R61E225KE11D |
| | | 1 × GRM155R61E105MA12D |
| | | 2 × GRM155R61A684KE15D |
| C_{1,L/R} | 1.53 F (derated) | 3 × GRM155R61A684KE15D |
| U_{X} | Half-bridge Gate driver | uP1966e (0.7 Ω/0.4 Ω |
| | | Source/Sink) |
| — | 5.6V Zener 0201 | GDZ5V6LP3-7 |
| — | 0.1 μF 35 V 0201 | GRM033R6YA104ME14D |
| L_{1L}, L_{1R} | Inductor | El Core |
| | 7.5 × 4 × 2.3, 2 | ML91S material |
| | mil air gaps | |
| | 78 nH self, 30 nH | |
| | mutual | |

TABLE 2
Comparison with other Recent 48 V to 1 V Converter Solutions

| | | | Pwr. Density | | Sys. Efficiency |
|---|---|---|---|---|---|
| | | | Watts/inch³ | Stg. Efficiency | (includes drv. loss) |
| | | | by box | Peak/Full | Peak/Full |
| Year | Topology | Sw. Freq. | vol. | Load | Load |
| 2024 | This Work | 1 MHz | 2,020 | 91.9%/88% | 90.1%/87.3% |
| | Doubler + SDIH | | | | |
| 2024 | 20-to-1 SBC [1] | 220 KHz | 759 | 94.1%/85.9% | 92.6%/85.6% |
| 2023 | Mini-LEGO [2] | 1515 KHz | 1,390 | 87.1%/84.1% | 84.1%/82.3% |
| 2023 | MSC [3] | 400 KHz | 621 | 93.1%/86.2% | 91.7%/85.8% |
| 2023 | 16-to-1 SBC [4] | 150 kHz | 464 | 94.7%/86.4% | 93.4%/86.1% |

[1] Y. Zhu et al., “A 1500-A/48-V-to-1-V Switching Bus Converter for Next-Generation Ultra-High-Power Processors,” IEEE Transactions on Power Electronics 2024.
[2] Y. Elasser, et al., “Mini-LEGO: A 1.5-MHz 240-A 48-V-to-1-V CPU VRM with 8.4-mm height for vertical power delivery,” IEEE Applied Power Electronics Conference and Exposition, 2023.
[3] P. Wang, et al., “MSC-POL: Hybrid GaN—Si Multistacked Switched Capacitor 48V PwrSiP VRM for Chiplets,” IEEE Transactions on Power Electronics, 2023.
[4] Y. Zhu, et al., “A 500-A/48-to-1-V Switching Bus Converter: A Hybrid Switched-Capacitor Voltage Regulator with 94.7% Peak Efficiency and 464-W/in3 Power Density,” Applied Power Electronics Conference and Exposition, 2023.

What is claimed is:

1. A point-of-load hybrid switched capacitor converter (HSCC) apparatus, comprising:
(a) a first stage comprising a switched capacitor converter (SCC) stage merged with a second stage comprising a symmetric dual-inductor hybrid (SDIH) Dickson-type converter stage;
(b) wherein the SCC stage comprises switches on either end of a flying capacitor for power and ground input, and switches on either side of the flying capacitor whose outputs are coupled to the second stage;
(c) wherein the first stage is fully softcharged by the second stage (SDIH) Dickson-type converter stage; and
(d) wherein the SDIH converter interleaves two inductor loaded hybrid switched capacitor converters having switches which are arranged for mirrored switching operation.

2. The apparatus of claim 1, wherein the first stage comprises a 2:1 (two-to-one) SCC stage.

3. The apparatus of claim 1, wherein the switches comprise Gallium Nitride (GaN) or MOSFET switches.

4. The apparatus of claim 3, wherein the gallium nitride switches are de-rated to safeguard against radiation total ionizing dose (TID) and single event effects (SEE).

5. The apparatus of claim 1, wherein operation of the HSCC apparatus is operated in two principle phases directed to different sides of the mirrored switching, and including additional free-wheeling phases which facilitate PWM voltage regulation.

6. The apparatus of claim 1, wherein the SDIH converter has an inherent dual interleaved high-side port capable of drawing charge from the flying capacitor of the SCC first stage, in an alternating fashion by the mirrored switching operation.

7. The apparatus of claim 1, wherein the SDIH converter is a merged multi-order second-stage SDIH converter.

8. The apparatus of claim 7, wherein the SDIH converter is a merged sixth-order second-stage SDIH converter.

9. The apparatus of claim 1, wherein the converter apparatus provides conversion from 48 Volts to 1 Volt.

10. The apparatus of claim 1, wherein output inductors in the second stage employ coupled inductors for reducing size and enhancing transient response.

11. The apparatus of claim 1, wherein flying capacitors in the SDIH converter stage each have the same capacitance value.

12. The apparatus of claim 1, wherein the merging of the SCC first stage with the SDIH converter second stage, in the HSCC apparatus, provides a reduction in required component count for the same overall voltage conversion ratio.

13. The apparatus of claim 1, further comprising gate drivers for driving the switches, wherein the gate drivers comprise ground referenced low side drivers and high-side drivers.

14. The apparatus of claim 1, wherein the high-side drivers leverage level-shifting circuitry integrated within a half-bridge driver.

15. A point-of-load hybrid switched capacitor converter (HSCC) apparatus, comprising:
(a) a first stage comprising a 2:1 (two-to-one) switched capacitor converter (SCC) stage merged with a second stage comprising a symmetric dual-inductor hybrid (SDIH) Dickson-type converter stage;
(b) wherein the SCC stage comprises switches on either end of a flying capacitor for power and ground input, and switches on either side of the flying capacitor whose outputs are coupled to the second stage;
(c) wherein the first stage is fully softcharged by the second stage (SDIH) Dickson-type converter stage;
(d) wherein the SDIH converter is a merged multi-order second-stage SDIH converter, which interleaves two inductor loaded hybrid switched capacitor converters having switches which are arranged for mirrored switching operation;
(e) wherein output inductors in the SDIH stage employ coupled inductors for reducing size and enhancing transient response;
(f) wherein operation of the HSCC apparatus is operated in two principle phases directed to different sides of the mirrored switching, and including additional free-wheeling phases which facilitate PWM voltage regulation; and
(g) wherein the SDIH converter has an inherent dual interleaved high-side port capable of drawing charge from the flying capacitor of the SCC first stage, in an alternating fashion by the mirrored switching operation.

16. The apparatus of claim 15 wherein the switches comprise Gallium Nitride (GaN), or MOSFET switches, or switches which have been de-rated to safeguard against radiation total ionizing dose (TID) and single event effects (SEE).

17. The apparatus of claim 15, wherein the converter apparatus provides conversion from 48 Volts to 1 Volt.

18. The apparatus of claim 15, wherein flying capacitors in the SDIH converter stage each have the same capacitance value.

19. The apparatus of claim 15, wherein the merging of the SCC first stage with the SDIH converter second stage, in the HSCC apparatus, provides a reduction in required component count for the same overall voltage conversion ratio.

20. A point-of-load hybrid switched capacitor converter (HSCC) method, comprising:
(a) merging a switched capacitor converter (SCC) first stage with a symmetric dual-inductor hybrid (SDIH) Dickson-type second converter stage;
(b) performing switching in the SCC stage of switches on either end of a flying capacitor for power and ground input, and switches on either side of the flying capacitor whose outputs are coupled to the second stage;
(c) fully softcharging the first stage by the second stage (SDIH) Dickson-type converter stage; and
(d) interleaving two inductor loaded hybrid switched capacitor converters in the SDIH converter utilizing switches arranged for mirrored switching operation.
